(19) United States
(12) Patent Application Publication
(10) Pub. No.: US 2026/0178059 A1
(43) Pub. Date: Jun. 25, 2026

(54) LEAD MOBILITY

(71) Applicant: TOYOTA JIDOSHA KABUSHIKI KAISHA, Aichi-ken (JP)

(72) Inventors: Daisuke SATO, Toyota-shi (JP); Masato IMAI, Numazu-shi (JP); Tomoya KATO, Yotsukaido-shi (JP); Hayato ADACHI, Susono-shi (JP)

(21) Appl. No.: 19/406,833

(22) Filed: Dec. 2, 2025

(30) Foreign Application Priority Data
Dec. 23, 2024 (JP) 2024-226440

(51) Int. Cl. G05D 1/698; G05D 1/225; G05D 109/10

(52) U.S. Cl. CPC G05D 1/6985; G05D 1/225; G05D 2109/10

(57) ABSTRACT

A lead mobility includes a controller configured to control wirelessly and an information obtaining device configured to obtain information from an external source. The lead mobility is configured to autonomously move in a lane and is capable of controlling at least one vehicle as at least one follower vehicle so as to follow the lead mobility by wireless communication. When the information obtaining device obtains specific information indicating a specific state in which an execution of a predetermined operation is required, the controller is configured to execute the predetermined operation.

### REFERENCE TO RELATED APPLICATIONS

This application claims priority from Japanese Patent Application No. 2024-226440 filed on Dec. 23, 2024. The entire content of the priority application is incorporated herein by reference.

### TECHNICAL FIELD

The present disclosure relates to a lead mobility for electronically towing a vehicle.

### BACKGROUND ART

Conventionally, for example, a remote control device disclosed in Japanese Patent No. 7424535 is known. The conventional remote control device is mounted on a lead mobility that moves autonomously, and guides a follower vehicle by a remote control so that the followed vehicle travels on a route on which the lead mobility moves. That is, the lead mobility has a function of controlling the follower vehicle so as to follow the lead mobility by wireless communication.

### SUMMARY

The utility of the lead mobility can be improved by providing the remote control device mounted on the lead mobility with a separate function in addition to a function of causing the follower vehicle to travel following the lead mobility by the remote control, that is, an electronic towing function.

In one aspect of the present disclosure, a lead mobility includes a controller configured to control wirelessly and an information obtaining device configured to obtain information from an external source. The lead mobility is configured to autonomously move in a lane and is capable of controlling at least one vehicle as at least one follower vehicle so as to follow the lead mobility by wireless communication. When the information obtaining device obtains specific information indicating a specific state in which an execution of a predetermined operation is required, the controller is configured to execute the predetermined operation.

### BRIEF DESCRIPTION OF DRAWINGS

The objects, features, advantages, and technical and industrial significance of the present disclosure will be better understood by reading the following detailed description of an embodiment, when considered in connection with the accompanying drawings, in which:

FIG. 1 is a side view for explaining a lead mobility;

FIG. 2 is a diagram for explaining various devices mounted on the lead mobility;

FIG. 3 is a block diagram for explaining a functional configuration of a remote control device;

FIG. 4 is a block diagram for explaining a functional configuration of a travel control device;

FIG. 5 is a diagram for explaining a specified operation of the lead mobility; and

FIG. 6 is a diagram for explaining a specified operation of the lead mobility according to a modification.

### DESCRIPTION

Hereinafter, a lead mobility 10 according to an embodiment of the present disclosure will be described in detail with reference to the drawings. In addition to the embodiments described below, the present disclosure can be implemented in various forms with various modifications and improvements based on the knowledge of those skilled in the art.

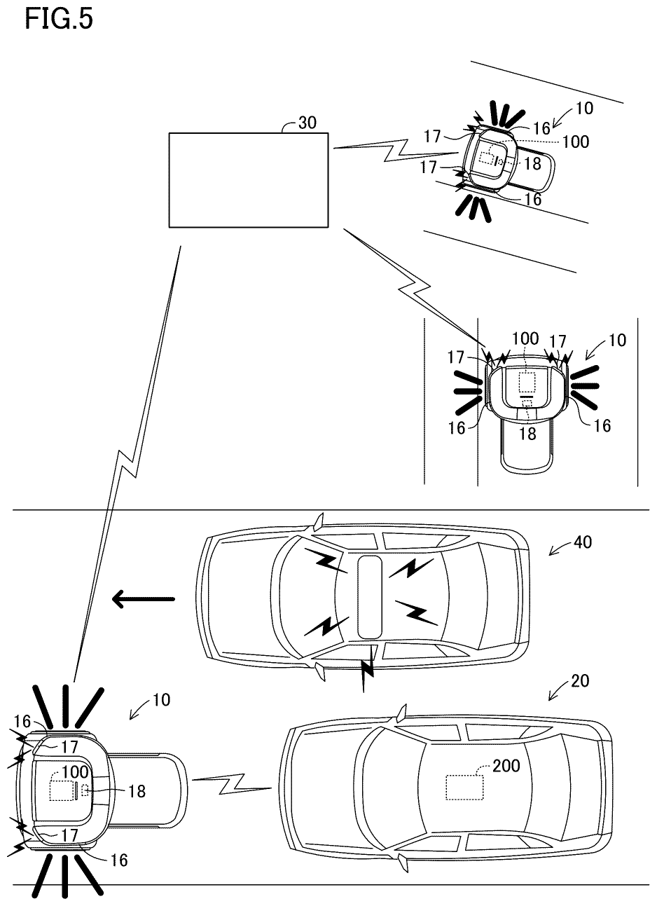

The lead mobility 10 is configured to be capable of autonomous traveling (capable of autonomous movement), and electronically tows a follower vehicle 20 that follows so as to maintain a specific positional relationship to a destination by controlling via wireless communication, that is, by a remote control (see FIG. 5). Here, as the lead mobility 10, a vehicle traveling on a road surface or a flying object flying in the air such as a drone can be exemplified, and in the present embodiment, a case where the lead mobility 10 is a vehicle will be described.

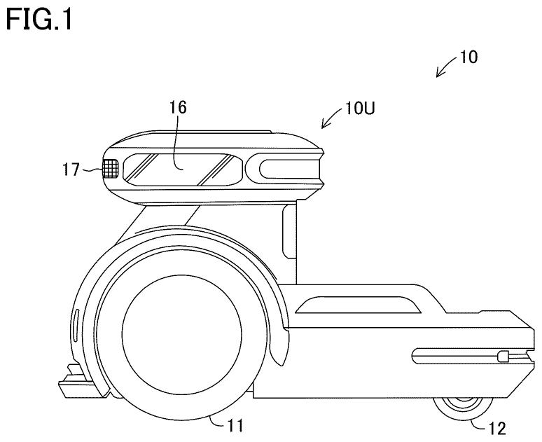

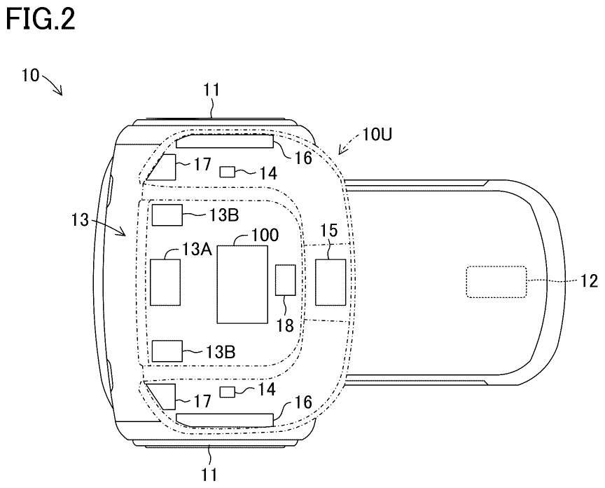

As shown in FIGS. 1 and 2, the lead mobility 10 of the present embodiment includes a pair of left and right driving wheels 11 and a driven wheel 12 for autonomous traveling. The pair of left and right driving wheels 11 independently and respectively driven by a pair of left and right traveling electric motors (not shown) that are driven by electric power supplied from a battery (not shown) mounted on a vehicle body of the lead mobility 10. Therefore, the lead mobility 10 can rotate around a rotation axis along a vertical direction by, for example, applying a left-right rotation speed difference (left-right driving force difference) to the left and right driving wheels 11. As a result, the lead mobility 10 can turn right or left, change direction, or turn (including pivot turning in which the lead mobility 10 rotates on a spot) during autonomous traveling without separately mounting a steering device that steers each of the left and right driving wheels 11.

It is noted that, in the lead mobility 10, the driving wheels 11 (more specifically, a traveling electric motor) generates a regenerative braking force according to a regenerative control by an autonomous driving controller 116 of a remote control device 100 described later. Thus, the lead mobility 10 can be stopped by the regenerative braking force.

A friction braking device (a drum brake device or a disc brake device) (not shown) is assembled to each of the driving wheels 11. Thus, in the lead mobility 10, the friction braking device also functions as a parking brake by generating a braking force by friction in a stopped state. It is noted that the friction braking device, for example, functions as a so-called electric brake in which an electric motor presses a brake shoe against a drum or presses a brake pad against a disc.

The driven wheel 12 is disposed behind the driving wheels 11 in a front-rear direction of the lead mobility 10. In the present embodiment, the driven wheel 12 is provided in a form of a universal caster so as to have one rotation axis extending along the vertical direction at a substantially central portion in a vehicle width direction (lateral direction) of the lead mobility 10. Accordingly, for example, when the lead mobility 10 travels (moves) while making a right or left turn or the like due to a rotational speed difference (driving force difference) of the driving wheels 11, the driven wheel 12 freely rotate around the rotation axis following a traveling direction accompanying the right or left turn or the like, thereby freely steering.

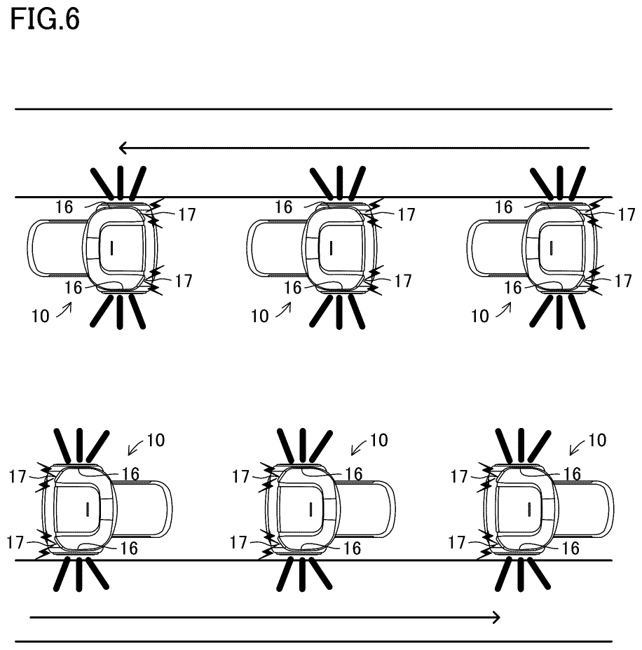

Moreover, as shown in FIG. 6, the lead mobility 10 includes a self-running detector 13, a position detector 14, a vehicle detector 15, a lighting device 16, a speaker 17 and an information obtaining device 18, which are accommodated in a vehicle body upper portion 10U. The self-running detector 13 detects relative positional relationship to an object such as an obstacle present in the traveling direction of the lead mobility 10 (hereinafter, also referred to as a “detection target”) when the lead mobility 10 autonomously travels, more specifically, the self-running detector 13 detects a relative distance between the lead mobility 10 and the obstacle.

Therefore, in the present embodiment, the self-running detector 13 is configured to include range finding devices such as a LiDAR (Light Detection And Ranging) 13A and a camera 13B. The LiDAR 13A obtains three-dimensional point cloud data indicating a three-dimensional position of a point cloud representing a detection target with high accuracy. Examples of the camera 13B include a stereo camera, a monocular camera, an RGB-D camera (depth camera), and the like, and the camera 13B obtains imaging data representing a direction in which the detection target object is present, a size, and the like. Instead of using the LiDAR 13A or the camera 13B, for example, a time of flight (ToF) sensor or the like can be used.

The self-running detector 13 outputs the obtained data, that is, the three-dimensional point cloud data and the imaging data to the remote control device 100 to be described later. Then, as described later, the remote control device 100 uses the obtained three-dimensional point cloud data and the obtained imaging data in simultaneous execution (SLAM: Simultaneous Localization and Mapping) of self-position estimation and environmental map creation for the lead mobility 10 to autonomously travel.

The position detector 14 includes, for example, a GNSS (Global Navigation Satellite System) receiver, and detects the position of the lead mobility 10 based on the received signal. Here, in the present embodiment, in the lead mobility 10, two position detectors 14 are disposed at each of the left and right positions in the vehicle width direction of the vehicle body upper portion 10U, that is, the two position detectors 14 are disposed so as to form a left and right pair. As for the number of the position detectors 14, only one position detector 14 may be disposed on the vehicle body upper portion 10U, or the three or more of position detectors 14 may be disposed on the vehicle body upper portion 10U.

The vehicle detector 15 is an apparatus for measuring various kinds of data used for estimating a relative position (hereinafter referred to as a “relative position”) of the follower vehicle 20 with respect to the lead mobility 10. Here, the relative position includes a relative orientation and posture (hereinafter, sometimes referred to as “relative posture”) of the follower vehicle 20 with respect to the lead mobility 10.

In the vehicle detector 15, a LiDAR as a distance meter that measures three-dimensional point cloud data of the follower vehicle 20 that is electronically towed by the lead mobility 10, is used. Here, in the remote control device 100 to be described later, for example, only the relative position of the follower vehicle 20 detected by the vehicle detector 15 may be obtained, and the relative posture and the traveling direction of the follower vehicle 20 may be estimated by grasping a temporal change or the like of the follower vehicle 20 based on the continuously obtained relative position.

The lighting device 16 is disposed at the highest position in the vehicle body upper portion 10U of the lead mobility 10 so that, for example, the periphery of the lead mobility 10 can be illuminated and visibility from surrounding vehicles and people is improved. As will be described later, the lighting device 16 illuminates the surroundings of the lead mobility 10 by light emission, notifies an abnormality by changing the emission color, or guides a vehicle or a person passing through the surroundings by light emission, as a predetermined operation when specific information is obtained. It is noted that, as the lighting device 16, for example, an LED having high luminance and capable of changing an emission color can be exemplified. Moreover, the lighting device 16 is turned on by power supplied from a battery (not shown) mounted on the lead mobility 10.

The speaker 17 is disposed in the vehicle body upper portion 10U of the lead mobility 10 so as to emit (output) sound forward in the traveling direction of the lead mobility 10, for example. As will be described later, as a predetermined operation when the specific information is obtained, the speaker 17 notifies an abnormality by outputting a sound or guides a vehicle or a person passing around by outputting a sound. It is noted that the speaker 17 may be disposed so as to emit (output) sound not only toward the front of the lead mobility 10 but also toward the rear or left and right directions.

The information obtaining device 18 obtains specific information issued to the lead mobility 10. Specifically, the information obtaining device 18 includes a wireless communication device that receives emergency information and guidance information, which are the specific information supplied from a center 30 (see FIG. 5) by wireless communication. In addition, the information obtaining device 18 is configured to include a microphone device that collects siren sound that is the specific information emitted by an emergency vehicle approaching the lead mobility 10.

Further, the lead mobility 10 includes the remote control device 100 that remotely operates the follower vehicle 20. The remote control device 100 executes a driving control so that the follower vehicle 20 maintains a specific positional relationship with respect to the lead mobility 10 by remote operation.

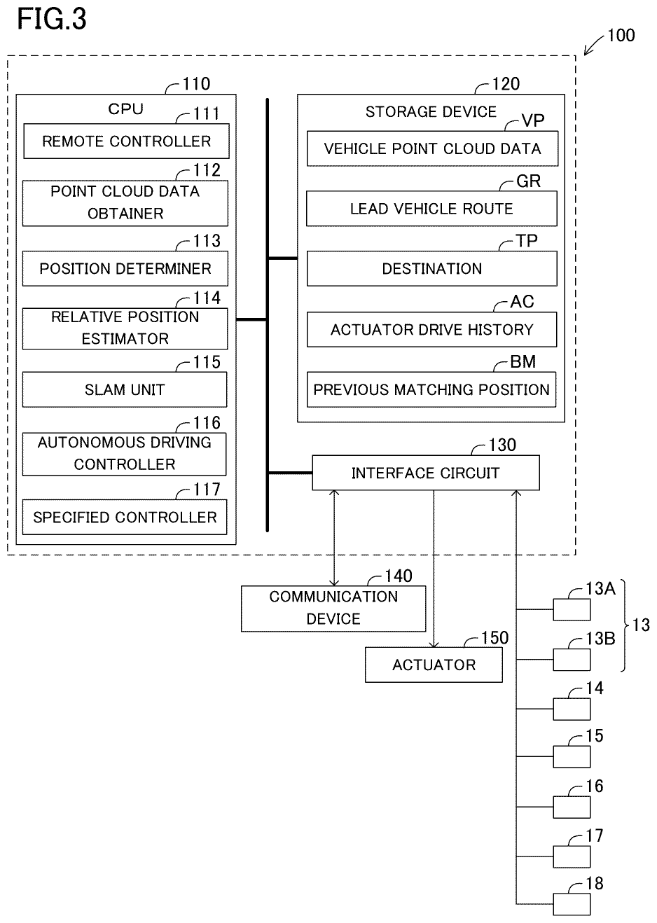

As shown in FIG. 3, the remote control device 100 includes a CPU 110, a storage device 120, an interface circuit 130, and a remote communication device 140. The CPU 110, the storage device 120, and the interface circuit 130 are connected via an internal bus so as to be bidirectionally communicable. The self-running detector 13 (the LiDAR 13A and the camera 13B), the position detector 14, the vehicle detector 15, the lighting device 16, the speaker 17, the information obtaining device 18, and the remote communication device 140 are connected to the interface circuit 130. The remote communication device 140 performs wireless communication with the follower vehicle 20 via a network or the like.

The CPU 110 executes a computer program stored in the storage device 120 in order to achieve at least some of the functions provided in the present embodiment. By executing the computer program, the CPU 110 functions as a remote controller 111, a point cloud data obtainer 112, a position determiner 113, a relative position estimator 114, a SLAM unit 115, the autonomous driving controller 116, and a specified controller 117, as illustrated in FIG. 3. However, some or all of these functions may be configured by a hardware circuit.

The remote controller 111 generates a control command for a remote control and transmits the control command to the follower vehicle 20 by wireless communication such that the follower vehicle 20 follows the lead mobility 10 while maintaining the specific positional relationship with the lead mobility 10, that is, as if the lead mobility 10 tows the follower vehicle 20 using a rope. It is noted that, in the following description, a state in which the remote controller 111 of the remote control device 100 mounted on the lead mobility 10 control the follower vehicle 20 via wireless communication so as to follow the lead mobility 10 as if towing by using the rope is called as “electronic towing”.

Here, the remote controller 111 can generate the control command as a command including, for example, a driving force or a braking force, and a steering angle. Alternatively, the remote controller 111 can generate the control command as a command including at least one of the position and the orientation of the follower vehicle 20 and a future traveling route. As a result, as will be described later, the follower vehicle 20 can travel autonomously by receiving the control command for the remote control.

The point cloud data obtainer 112 obtains three-dimensional point cloud data measured by the vehicle detector 15. The position determiner 113 determines a start position at which matching of vehicle point cloud data VP with the three-dimensional point cloud data obtained by the point cloud data obtainer 112 is started.

Here, the vehicle point cloud data VP functions as a template point cloud for estimating at least one of the position and the orientation (posture) of the follower vehicle 20. The vehicle point cloud data VP can include information for specifying the orientation (posture) of the follower vehicle 20. Accordingly, the position determiner 113 and the relative position estimator 114 can estimate the position and orientation (posture) of the follower vehicle 20 in the three-dimensional point cloud data with high accuracy by template matching using the vehicle point cloud data VP.

In the present embodiment, the position determiner 113 determines the start position of the template matching by using information related to the position of the follower vehicle 20 in the three-dimensional point cloud data (hereinafter, also referred to as “position-related information”). Here, the position-related information is data used to estimate the position of the follower vehicle 20 in the three-dimensional point cloud data and/or the position near the follower vehicle 20 in the three-dimensional point cloud data.

The relative position estimator 114 estimates a relative position including a relative orientation (posture), that is, a relative posture of the follower vehicle 20 with respect to the lead mobility 10 in the obtained three-dimensional point cloud data. Here, as the relative position, for example, a relative distance to the follower vehicle 20 in the traveling direction, a deviation of the follower vehicle 20 in the vehicle width direction with respect to the movement trajectory of the lead mobility 10, a relative turning posture (right/left turning posture) of the follower vehicle 20 with respect to the lead mobility 10, and the like can be exemplified with reference to the position and posture of the lead mobility 10.

In the present embodiment, the relative position estimator 114 estimates the relative position including the relative posture of the follower vehicle 20 in the three-dimensional point cloud data by executing the template matching using the vehicle point cloud data VP on the three-dimensional point cloud data. For the template matching of the vehicle point cloud data VP with respect to the three-dimensional point cloud data executed by the position determiner 113 and the relative position estimator 114, for example, a well-known interactive closest point (ICP) algorithm, a well-known normal distribution transform (NDT) algorithm, or the like can be used.

The SLAM unit 115 executes SLAM using data (imaging data or the three-dimensional point cloud data) detected by the self-running detector 13, and executes generation of a map used by the lead mobility 10 in autonomous traveling, and the like. The autonomous driving controller 116 causes the lead mobility 10 to autonomously travel by controlling the operation of an actuator 150 such as a traveling electric motor that drives the driving wheels 11 mounted on the lead mobility 10 or an electric motor that constitutes the friction braking device. Specifically, the autonomous driving controller 116 controls the operation of the actuator 150 to detect the position of the lead mobility 10 based on the GNSS signal received by the position detector 14, for example, when causing the lead mobility 10 to autonomously travel to a set destination TP along a lead vehicle route GR using the map generated by the SLAM unit 115.

When the specific information is obtained by the information obtaining device 18, the specified controller 117 executes an operation control so that the lead mobility 10 performs a predetermined operation. Here, examples of the specific information include emergency information which is information issued from a government or a public institution after an occurrence of a disaster or when an occurrence of a disaster is predicted, identification information for identifying a sound (specifically, identifying a frequency of a sound and a pattern of issuing a sound) emitted from each siren when an emergency vehicle which is a vehicle dispatched in response to the occurrence of a disaster, an emergency, a fire, or a crime travels, and guidance information for guiding a plurality of participants in an event venue. Examples of the predetermined operation include an operation of moving the lead mobility 10 or the lead mobility 10 and the follower vehicle 20, which is a following vehicle that is being controlled, toward the edge in the width direction of the lane (pull-over operation), an operation of turning on the lighting by the lighting device 16 (lighting operation), and an operation of emitting a guidance voice from the speaker 17 (guidance operation).

Examples of the storage device 120 include a RAM, a ROM, an HDD, and an SSD. The readable and writable area of the storage device 120 stores the vehicle point cloud data VP, the lead mobility route GR, the destination TP, an actuator drive history AC, and a previous matching position BM.

Here, the lead mobility route GR is a target route that can be determined for the lead mobility 10 to travel. Moreover, the destination TP is a movement destination of the lead mobility 10 that can be arbitrarily set. When the autonomous driving controller 116 causes the lead mobility 10 to autonomously travel (autonomously move) using the map generated by the SLAM unit 115 based on the data output from the self-running detector 13, the lead mobility route GR can be omitted. However, in this case, for example, the autonomous driving controller 116 generates a travel route to the set destination TP and causes the lead mobility 10 to travel (move) along the generated travel route.

The actuator drive history AC is a history of input and output values in each actuator 230 of the follower vehicle 20 described later. The actuator drive history AC is, for example, a history of control command values transmitted from the remote control device 100 to the follower vehicle 20. It is noted that the actuator drive history AC may be, for example, an actual measurement value detected by detectors of the follower vehicle 20, such as a vehicle speed, a steering angle, a braking force, or a rotation angle of the follower vehicle 20. The previous matching position BM is a coordinate value of a position at which the template matching between the three-dimensional point cloud data and the vehicle point cloud data VP previously executed by the relative position estimator 114 of the remote control device 100 described above is completed.

Examples of the follower vehicle 20 include a passenger car, a truck, a bus, a construction vehicle, and a two-wheeled vehicle (see FIG. 5). Here, in the present embodiment, a case where an electric vehicle (Battery Electric Vehicle: BEV), which is a passenger vehicle, is adopted as the follower vehicle 20 will be exemplified. Incidentally, it is needless to say that the passenger vehicle is not limited to the electric vehicle and may be, for example, a vehicle having an internal combustion engine as a drive source, a hybrid vehicle (HEV) or a plug-in hybrid vehicle (PHEV) having an internal combustion engine and an electric motor as drive sources, or a vehicle (FCEV) having a fuel cell and an electric motor.

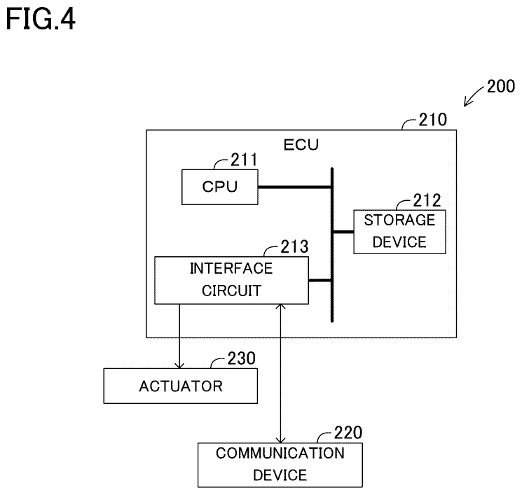

As shown in FIG. 4, the follower vehicle 20 includes a travel control device 200. The travel control device 200 includes an electronic control unit (ECU) 210. The ECU 210 is a microcomputer including a CPU 211, a memory 212, and an interface circuit 213 as main components. It is noted that the CPU 211, the memory 212, and the interface circuit 213 are connected via an internal bus so as to be bidirectionally communicable. The actuator 230 and a vehicle communication device 220 are connected to the interface circuit 213. The vehicle communication device 220 wirelessly communicates with the remote communication device 140 of the remote control device 100 mounted on the lead mobility 10 via a network or the like.

The CPU 211 executes a computer program stored in a readable/writable area of the memory 212 to implement a function of controlling driving of the follower vehicle 20. Here, the driving control is, for example, adjustment of acceleration, deceleration, speed, steering angle, and the like of the follower vehicle 20, that is, various controls for driving the actuators 230 that exert the functions of “running”, “turning”, and “stopping” of the follower vehicle 20.

In the present embodiment, although not shown, examples of the actuator 230 include an actuator including a traveling electric motor or the like constituting a driving device for accelerating or decelerating the follower vehicle 20, an actuator including an electric motor or the like constituting a braking device for decelerating the follower vehicle 20, and an actuator including a steering motor (electric motor) or the like constituting a steering device for changing the traveling direction of the follower vehicle 20. It is noted that the actuator 230 is driven by electric power supplied from a battery (not shown) mounted on the follower vehicle 20.

When the driver is riding on the follower vehicle 20, the CPU 211 can cause the follower vehicle 20 to travel by controlling the operation of the actuator 230 in accordance with the operation of the driver. The CPU 211 can cause the follower vehicle 20 to follow and travel so as to maintain a specific positional relationship with the lead mobility 10 by controlling the operation of the actuator 230 in accordance with the control command transmitted from the remote control device 100 regardless of whether or not the driver is on board the follower vehicle 20 (see FIG. 5).

Next, an operation control by the specified controller 117 of the remote control device 100 will be described. As described above, when the specified controller 117 obtains the specific information while the lead mobility 10 is electronically towing the follower vehicle 20, the specified controller 117 executes the operation control so that the lead mobility 10 achieves the predetermined operation. Specifically, as shown in FIG. 5, the lead mobility 10 is configured to be capable of communicating with the center 30 that transmits the specific information via a network. As a result, the lead mobility 10 obtains the specific information transmitted from the center 30 via the information obtaining device 18.

Here, the specific information includes at least emergency information issued from a government or a public institution after the occurrence of a disaster and when the occurrence of a disaster is predicted, identification information for identifying a sound emitted from each siren as an emergency vehicle dispatched in response to the occurrence of a disaster, an emergency, a fire, or a crime travels, and guidance information for guiding a person in a specific area. It is noted that, in the present embodiment, a case where the specified controller 117 obtains emergency information, which is the specific information, by the information obtaining device 18 will be described as an example. In the present embodiment, a case will be described as an example in which the specified controller 117 controls the operation of the lead mobility 10 such that the lead mobility 10 performs the pull-over operation to the edge of the lane and the lighting operation as the predetermined operation when the emergency information is obtained.

When the information obtaining device 18 obtains the emergency information from the center 30, the remote control device 100 stops the lead mobility 10 and the follower vehicle 20 that is electronically towed by the remote control device 100 at the edge of the lane in which the vehicle is traveling. Therefore, the specified controller 117 cooperates with the autonomous driving controller 116 and the remote controller 111 to control the operation of the lead mobility 10 so as to achieve the pull-over operation. That is, upon obtaining of the emergency information, the specified controller 117 cooperates with the autonomous driving control unit 116 to bring the lead mobility 10 close to the edge of the lane and stop the lead mobility 10. In addition, the specified controller 117 cooperates with the remote controller 111 in accordance with the control by the autonomous driving controller 116 to bring the follower vehicle 20 close to the edge of the lane and stop the follower vehicle 20 so as to follow the lead mobility 10.

Here, as shown in FIG. 5, the emergency information is simultaneously (collectively) issued from the center 30 to the plurality of lead mobilities 10. For this reason, when the lead mobility 10 is electronically towing the follower vehicle 20 at the time when the emergency information is issued, the lead mobility 10 and the follower vehicle 20 come close to the edge of the lane and stop due to the pull-over operation. If the lead mobility 10 is not electronically towing the follower vehicle 20 at the time when the emergency information is issued, that is, if the lead mobility 10 is traveling alone, the lead mobility 10 stops at the edge of the lane by the pull-over operation. As described above, after the emergency information is issued, the lead mobility 10, or the lead mobility 10 and the follower vehicle 20 come close to the edge of the lane and stop, and thus it is possible to prevent the passage of an emergency vehicle 40 dispatched in response to the occurrence of a disaster or the like from being obstructed, for example.

Subsequently, in accordance with the issuance of the emergency information, the specified controller 117 causes the lighting device 16 to perform the lighting operation so that, for example, people walking on a road shoulder adjacent to the edge of the lane at night can move safely. That is, the specified controller 117 executes the operation control so that the lighting device 16 of the lead mobility 10 stopped at the edge of the lane achieves the lighting operation. As a result, in the lead mobility 10, the lighting device 16 provided in the vehicle body upper portion 10U, for example, turns on by emitting white light, making it possible to brightly illuminate the surroundings, including the road shoulder.

As described above, the emergency information is simultaneously issued to the plurality of lead mobilities 10. For this reason, the specified controller 117 of each of the plurality of lead mobilities 10 that are stopped by the pull-over operation also turns on the lighting, as described above, by the lighting device 16 provided in the vehicle body upper portion 10U of each of the plurality of lead mobilities 10 that are targets of the operation control. Therefore, for example, even in a situation in which a power failure occurs due to the occurrence of a disaster or the like, the plurality of lead mobilities 10 are scattered, and thus it is possible to illuminate feet of people walking on a road shoulder or a sidewalk.

When each of the plurality of lead mobilities 10 causes the lighting device 16 to turn on the lighting, the center 30 can instruct the movement of the lead mobilities 10 so that, for example, the distance between the lead mobilities 10 concentrated in one area increases, that is, the lead mobilities 10 are dispersed in a wide area. As a result, the lead mobility 10 can move, for example, to a place where illumination is insufficient at night and turn on the illumination by the lighting device 16 at the movement destination under the control of the autonomous driving controller 116 according to an instruction from the center 30. This allows people to move, for example, on the road shoulder relatively easily and relatively safely even at night.

In addition, in each of the plurality of lead mobilities 10, for example, in a state in which the lead mobility 10 is stopped by the pull-over operation as described above, the specified controller 117 can achieve a voice output operation of emitting a voice of evacuation guidance from the speaker 17 to people walking on the road shoulder or the sidewalk. As a result, for example, in a situation where people evacuate due to the occurrence of a disaster or the like, each of the plurality of lead mobilities 10 provides evacuation guidance, so that smooth evacuation can be promoted.

As can be understood from the above description, the lead mobility 10 can autonomously move and operate the follower vehicle 20 to follow the lead mobility 10 by wireless communication. The lead mobility 10 includes the remote control device 100 as a controller that executes a maneuver by wireless communication, and the information obtaining device 18 that obtains information transmitted from the center 30 as an external device. The specified controller 117 of the remote control device 100 is configured to execute the operation control for achieving the pull-over operation, the lighting operation by the lighting device 16, and the sound output operation by the speaker 17, which are the predetermined operations, when the information obtaining device 18 obtains the emergency information as the specific information indicating the specific situation in which the predetermined operation set in advance needs to be executed.

According to this, when the identification information is obtained, the remote control device 100 can perform the operation control such that the specified controller 117 performs at least one of the pull-over operation, the lighting operation, and the sound output operation on the lead mobility 10. As a result, the lead mobility 10 can cause the follower vehicle 20 to follow the lead mobility by controlling through wireless communication, and in addition, can execute the predetermined operation according to the occurrence of a disaster or the like, that is, a specific situation indicated by the emergency information that is the specific information. Therefore, a practicality of the lead mobility 10 can be enhanced.

In the above-described embodiment, the case where the lead mobility 10 performs the pull-over operation when obtaining the emergency information has been described. When the emergency vehicle 40 approaches from behind while the lead mobility 10 is electronically towing the follower vehicle 20, the lead mobility 10 or both of the lead mobility 10 and the follower vehicle 20 needs to approach the edge of the lane so as not to obstruct the passage of the emergency vehicle 40. In this case, in the remote control device 100 of the lead mobility 10, when the information obtaining device 18 obtains the identification information for identifying the emergency vehicle 40, that is, the frequency of the sound generated by the siren and a sound generation pattern, the emergency vehicle 40 is approaching. Therefore, the specified controller 117 cooperates with the autonomous driving controller 116 and the remote controller 111 to control the operation of the lead mobility 10 so as to achieve the pull-over operation, whereby the follower vehicle 20 can also be moved toward the edge of the lane.

Here, the specified controller 117 can determine whether the approaching emergency vehicle 40 is an ambulance, a fire engine, or a police car based on the frequency of the sound and the sound generation pattern (sound interval) represented by the identification information obtained by the information obtaining device 18. In particular, in the case of the fire engine, the vehicle width may be larger than that of an ambulance or a police car. Therefore, the specified controller 117 controls the pull-over operation in cooperation with the autonomous driving controller 116 and the remote controller 111 so that the lead mobility 10 and the follower vehicle 20 are moved much closer to the edge of the lane.

In addition, in a case where the lead mobility 10 is present in an event venue as a specific area, the lead mobility 10 can lead (guide) participants who are people participating in the event to a specific position such as an entrance of a building or an exit of the event venue. In this case, in the plurality of lead mobilities 10 present in the event venue, the information obtaining device 18 of each of the plurality of lead mobilities 10 obtains guidance information for guiding the participant to the specific position. As a result, the specified controller 117 of the remote control device 100, for example, cooperates with the autonomous driving controller 116 to align the lead mobility 10 along a guide route to the specific position by the pull-over operation as illustrated in FIG. 6. Then, the specified controller 117 controls the operation of the lead mobility 10 so as to achieve the voice output operation of outputting a guidance voice to the specific position from the speaker 17 toward the participant moving in the direction of the arrow illustrated in FIG. 6.

In this case, the specified controller 117 can guide (lead) the participant along the guidance route by controlling the operation of the lead mobility 10 so as to achieve lighting by the lighting device 16, specifically, the lighting operation of turning on the lighting or blinking the lighting, in addition to the voice output operation. In this case, the specified controller 117 changes the lighting device 16 from white illumination to emit light in a color (for example, blue, yellow, green, or the like) that is easily visually recognized by the participant, so that the participant can easily move along the guidance route.

What is claimed is

1. A lead mobility, comprising:
a controller configured to control wirelessly; and
an information obtaining device configured to obtain information from an external source,
wherein the lead mobility is configured to autonomously move in a lane and is capable of controlling at least one vehicle as at least one follower vehicle so as to follow the lead mobility by wireless communication, and
wherein, when the information obtaining device obtains specific information indicating a specific state in which an execution of a predetermined operation is required, the controller is configured to execute the predetermined operation.

2. The lead mobility according to claim 1,
wherein the specific information includes emergency information issued from a government or a public institution after an occurrence of a disaster or when an occurrence of a disaster is predicted, identification information for identifying a sound emitted from each siren when an emergency vehicle which is a vehicle dispatched in response to an occurrence of a disaster, an emergency, a fire, or a crime travels, and guidance information for guiding a plurality of participants in a specific area.

3. The lead mobility according to claim 1,
wherein the predetermined operation includes a first operation in which the mobility or both the mobility and the follower vehicle are moved toward an edge of the lane in a width direction of the lane, a second operation in which a lighting device mounted on the mobility is turned on, a third operation in which a voice is emitted from a speaker mounted on the mobility, both the first operation and the second operation, both the first operation and the third operation, both the second operation and the third operation, or all of the first operation, the second operation and the third operation.

4. The lead mobility according to claim 1,
wherein the specific information is simultaneously transmitted to a plurality of mobilities each as the mobility 5. The lead mobility according to claim 1,
wherein the specific information is simultaneously transmitted from a center communicable with the information obtaining device.
